(19) United States
(12) Patent Application Publication
(10) Pub. No.: US 2016/0280846 A1
(43) Pub. Date: Sep. 29, 2016

(54) CURABLE COMPOSITIONS

(71) Applicant: DOW GLOBAL TECHNOLOGIES LLC, Midland, MI (US)

(72) Inventors: Krishnan Karunakaran, Lake Jackson, TX (US); Marvin L. Dettloff, Lake Jackson, TX (US); Nikhil K.E. Verghese, Lake Jackson, TX (US); Ha Q. Pham, Lake Jackson, TX (US)

(21) Appl. No.: 15/032,324

(22) PCT Filed: Dec. 2, 2014
(86) PCT No.: PCT/US2014/067995

§ 371 Date: Apr. 27, 2016

Related U.S. Application Data
(60) Provisional application No. 61/917,482, filed on Dec. 18, 2013.

(51) Int. Cl. C08G 59/50; C08G 59/42; C08G 59/24

(52) U.S. Cl. CPC C08G 59/50; C08G 59/245; C08G 59/4215

(57) ABSTRACT

A dual cure system including at least two different and separate types of chemical reactions occurring as the process of the present invention proceeds including, for example, the following two reactions: (1) free radical polymerization of methacrylated or acrylated polyol; and (2) an epoxy-curing agent reaction. The dual cure system of the present invention advantageously provides a first cure reaction of methacrylated or acrylated polyol followed by a second epoxy-curing agent thermoset reaction to form a cured thermoset exhibiting an elongation property of greater than about 5%.

### FIELD

The present invention is related to a novel curable epoxy resin composition for manufacturing thermosets, in particular thermosets having useful mechanical properties such as high elongation and high modulus.

### BACKGROUND

Heretofore, various methods have been used in an attempt to improve the elongation property of epoxy thermosets. For example, U.S. Pat. No. 7,157,143 discloses a two-component epoxy adhesive curable composition which, upon curing, provides a thermoset having an elongation at break in the range of from 5 percent (%) to 51% with a low modulus, e.g., a Young's modulus, in the range of from 1.9 ksi (13 MPa) to 60 ksi (414 MPa). The components of the curable composition described in U.S. Pat. No. 7,157,143 include (1) diglycidylether of bisphenol A, (2) an epoxy resin made from polypropylene glycol, (3) an acrylate, (4) a phenol and (5) an amine curing agent. The amine curing agent can be for example triethylenetetraamine such as a commercial triethylenetetraamine curing agent commercially available under the tradename Versamid 140. The curable composition disclosed in U.S. Pat. No. 7,157,143 when cured, provides a thermoset having low modulus (strength); and such low modulus thermosets may not be suitable for strength-based applications like composites for pressure vessels, wind blades and the like.

U.S. Pat. No. 5,679,719 discloses a method for preparing a filament winding fiber/resin composite from a curable composition including (1) an epoxy resin, (2) a hardener, (3) an olefinic monomer, (4) a photoinitiator, and (5) a peroxide. The method disclosed in U.S. Pat. No. 5,679,719 is focused on obtaining a curable composition having a low viscosity (e.g., a viscosity of 2000 centipoise or less) and a long pot-life (e.g., a pot-life of at least 2 hours at temperatures ranging from ambient temperature to 60° C.). A low viscosity and a long pot-life are properties a curable composition must have in order for the curable composition to be suitable for a filament winding operation. U.S. Pat. No. 5,679,719 does not disclose a curable composition that, upon curing, provides a thermoset exhibiting high elongation; or any advantage of a thermoset having high elongation.

### SUMMARY

The present invention is directed to a multiple cure system wherein a curable composition undergoes at least two curing reactions upon activating the curing mechanisms of the curable composition. For example, when the curable composition undergoes two cure reactions to fully cure the composition to form a thermoset, the composition can be referred to as a “dual cure system”.

The duel cure system of the present invention includes at least two different and separate types of chemical reactions that occur as the curing process of the present invention curable composition proceeds. For example, the dual cure system of the present invention includes at least: (1) free radical polymerization of a methacrylated or acrylated polyol; and (2) a curing reaction between an epoxy compound and a curing agent (e.g., an epoxy resin-curing agent condensation reaction). In the present invention process, the methacrylated or acrylated polyol cures first via free radical polymerization before the epoxy-curing agent thermoset reaction takes place. In the present invention process, the polymerized methacrylated or acrylated polyol forms a network of its own and undergoes phase separation during the epoxy-curing agent thermoset network formation.

In accordance with the present invention, one embodiment is directed to a curable system or composition including (a) a methacrylated or acrylated polyol, (b) a free radical initiator, (c) an epoxy resin, and (d) a hardener. Advantageously, the curable composition of the present invention, upon curing, undergoes essentially a “dual cure” process including first, a polymerization reaction of the methacrylated or acrylated polyol component to provide a network swollen, expanded or saturated with an unreacted epoxy resin-curing agent blend; and then second, a reaction of the epoxy resin component with the hardener component, such as an amine hardener, which forces the methacrylated or acrylated polyol network to phase separate from the epoxy resin-amine reaction product. The final cured thermoset product resulting from curing the curable composition of the present invention includes an epoxy thermoset with a crosslinked methacrylated or acrylated polyol forming a second phase in the thermoset.

Another embodiment of the present invention includes a process for preparing the above curable composition.

Still another embodiment of the present invention is directed to a thermoset product prepared from the above curable composition; and a process for preparing such thermoset.

The cured epoxy thermoset of the present invention beneficially has a combination of a high modulus and an unusually/unexpectedly high elongation—properties which are not found in conventional epoxy-curing agent thermosets. Typically, conventional epoxy thermosets can have a high modulus with a low elongation or a low modulus with a high elongation; but not both a high modulus and a high elongation. However, the epoxy thermoset of the present invention surprisingly has both a high modulus and a high elongation.

Another advantage of the curable composition and the thermoset of the present invention includes, for example, the curable composition can have a very low viscosity (e.g., a viscosity of less than about 200 mPa-s) which makes the curable composition more readily processable. Still another advantage of the curable composition is that the reactivity of the curable composition can be “tuned” by an operator. The “tunable reactivity” characteristic of the curable composition of the present invention can be defined herein, with reference to the curable composition, as the ability to modify the cure profile of the curable composition by using free radical initiators having varying efficiency and/or by using hardeners of varying reactivity (e.g., an amine curing agent such as triethylenetetraamine provides a fast reaction while an amine curing agent such as methylene dianiline provides a very slow reaction).

The thermoset prepared from the above curable composition can be useful in various high-strength applications such as for producing composites.

### DETAILED DESCRIPTION

In its broadest scope, the present invention provides a thermoset having high elongation prepared by curing a curable epoxy resin composition which includes a mixture of the following compounds: (I) at least one methacrylated or acrylated polyol compound; (II) at least one free radical initiator; (III) at least one epoxy compound; and (IV) at least one curing agent; and then, allowing the curable composition to cure via a dual cure mechanism or process. “Dual cure system, formulation or composition” herein, with reference to a composition, means a curable composition that, upon mixing the above components of the composition, the composition is capable of being cured via two different mechanisms or reactions, such as: (1) free radical curing, and (2) epoxy-curing agent condensation curing.

As the components of the curable composition react with each other, i.e., the composition proceeds through the curing process, a first curing reaction occurs wherein the at least one methacrylated or acrylated polyol cures first by either (i) thermal curing or (ii) free radical polymerization curing with the at least one free radical initiator. In the above first curing reaction, the cured methacrylated or acrylated polyol provides a network. Then, the first curing phenomena is followed by a second curing reaction wherein the at least one epoxy compound cures second with the at least one curing agent by heat to form the thermoset network. The polymerized methacrylated or acrylated polyol which forms its own network in the first curing reaction then undergoes phase separation during the epoxy-curing agent thermoset formation. The resulting cured thermoset beneficially has a high elongation property. “High elongation” herein, with reference to a composition, means an elongation property of greater than (>) about 5%. The elongation property of a cured thermoset can be measured using, for example, the method described in ASTM D-638.

“Phase separation” or “phase separating” herein, with reference to a composition, refers to the action of the curable composition forming a distinct secondary phase wherein the dimensions of the secondary phase can be in the range of nanometer to micrometer range, and wherein the dimensions can be measured by various analytical techniques such as by scanning electron microscopy (SEM) and transmission electron microscopy (TEM).

The curable composition of the present invention may include, as a first component (I), at least one polyol capped with methacrylate groups (methacrylated or acrylated polyols). Preferably, the methacrylated or acrylated polyol useful in the present invention is capable of phase separating during curing in presence of epoxy resin and epoxy resin curing agents. In one embodiment, the methacrylated or acrylated polyols have a general chemical structure as shown in Structure (I) as follows:

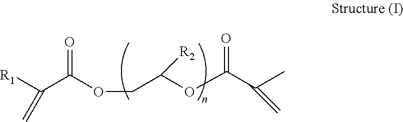

In the above general Structure (I), R₁ can be H or CH₃ and R₂ can be H, CH₃ or higher homologues or a mixture thereof; and n can be an integer of from 3 to about 30.

In one embodiment, the methacrylated or acrylated polyols useful in the present invention, as illustrated by above Structure (I), can be obtained, for example, by producing the methacrylated or acrylated polyol using conventional methods known in the art such as by (1) reacting a polyether polyol with methacrylic acid in the presence of p-toluenesulfonic acid as described in U.S. Patent Application Publication No. 2012/0245246A1, incorporated herein by reference; or (2) reacting a polyol with a diisocyanate and then reacting the resulting reaction product with a hydroxyalkyl methacrylate as disclosed in EP0173085B 1, incorporated herein by reference. Other conventional methods known in the art can be used for sourcing the methacrylated or acrylated polyol useful in the present invention. In another embodiment, the methacrylated or acrylated polyols useful in the present invention, as illustrated by above Structure (I), can be commercially obtained from various manufacturers known in the industry.

In one preferred embodiment, the methacrylated polyol useful in the present invention can include, for example, a product generally represented by the chemical structure as described in Structure (II) as follows:

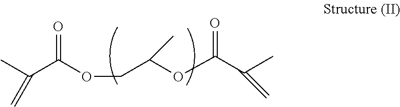

In the above Structure (II), n can be an integer of from 3 to about 10. As one illustrative embodiment of the present invention, the above Structure (II) may include, for example, polypropylene glycol dimethacrylate (where n=7) commercially available from Sartomer under the tradename SR 644.

In another preferred embodiment, the methacrylated polyol useful in the present invention can include, for example, a product generally represented by the chemical structure as described in Structure (III) as follows:

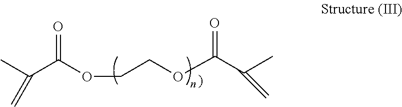

In the above Structure (III), n can be the same as described with reference to Structure (I), that is, n can be an integer of from 3 to about 10. As one illustrative embodiment of the present invention, the above Structure (III) may include, for example, polyethylene glycol dimethacrylate (where n=7) commercially available from Sartomer under the tradename SR 603.

The concentration of the methacrylated or acrylated polyol used in the present invention should be sufficient (1) to allow the methacrylated or acrylated polyol to cure, and (2) when cured, to form a network and phase separate during the curing of epoxy resin with a curing agent such as an amine. For example, the concentration of methacrylated or acrylated polyol can be in the range of generally from about 7 weight percent (wt %) to about 25 wt % in one embodiment, from about 9 wt % to about 20 wt % in another embodiment, and from about 10 wt % to about 15 wt % in still another embodiment. At concentrations lower than 7 wt %, the resulting cured thermoset does not exhibit high elongation; and at concentrations higher than 25 wt %, the mechanical properties of the resulting cured thermoset may start to decrease.

The free radical initiator useful as component (II) in the present invention can include for example a thermal free radical initiator (i.e., an initiator which generates free radicals on heating); a UV free radical initiator (i.e., an initiator which generates free radicals by UV light absorption); or a combination thereof.

A wide range of conventional thermal free radical initiators are known in the art and can be used in the present invention. In one embodiment, the thermal free radical initiator compound useful in the present invention can include for example peroxides such as for example methyl ethyl ketone peroxide, benzoyl peroxide, cumene peroxide or mixtures thereof; peroxyalkanoates such as for example cumyl peroxy neodecanoate, 1,1,3,3-tetramethylbutyl peroxyneodecanoate, or mixtures thereof; and any combination of the above initiators. A broad range of commercially available initiators such as initiators sold under the tradename of Trigonox available from Akzo Nobel can also be used in the present invention.

A wide range of conventional ultra violet (UV) light promoted free radical initiators are known in the art and can be used in the present invention. The use of a UV free radical initiator is an alternate embodiment to the use of a thermal free radical initiator and thermally curing the curable composition during the first curing reaction. Generating the first curing reaction of the dual cure reactions of the present invention can include using a UV promoted free radical initiator to promote free radical polymerization of the methacrylated or acrylated polyol present in the curable composition. For example, the free radical initiator can be a UV photoinitiator and the UV photoinitiator can be used under UV light conditions to undergo the first curing reaction and cure the methacrylated or acrylated polyol. The first curing reaction mechanism results in a network that can phase separate during the subsequent second curing reaction.

The methacrylated or acrylated polyol useful in forming the UV curable composition of the present invention can be, for example, any of the methacrylated or acrylated polyols described above. The UV free radical initiator useful in forming the UV curable composition of the present invention can be, for example, a initiator such as 2,2-dimethoxy 2-phenyl acetophenone, 1-hydroxycyclohexyl phenyl ketone; and mixtures thereof. A broad range of commercially available initiators, for example available from Sigma Aldrich, can also be used in the present invention.

When curing the curable composition via the alternate embodiment of using a UV free radical initiator to promote free radical polymerization, the concentration of the UV free radical initiator used in the dual cure system above should be sufficient to provide a network that phase separates during the subsequent second curing reaction between the epoxy resin and epoxy resin curing agent. For example, the concentration of UV free radical initiator can be in the range of generally from about 0.1 wt % to about 4 wt % in one embodiment, from about 0.1 wt % to about 3 wt % in another embodiment, and from about 0.1 wt % to about 2 wt % in still another embodiment. At concentrations lower than 0.1 wt % and at concentrations higher than 4 wt %, the resulting cured thermoset does not exhibit high elongation.

The curable composition of the present invention may include at least one epoxy resin compound as component (III) from a wide variety of conventional epoxy compounds. The curable composition may include, for example, at least one epoxy compound that is capable of forming the epoxy matrix in a final cured thermoset and that is capable of allowing the cured methacrylated or acrylated polyol phase to phase separate from the cured epoxy matrix. The epoxy resin useful in the curable composition of the present invention may include one or more different epoxy compounds for example, aromatic glycidyl ethers; aliphatic glycidyl ethers; cycloaliphatic glycidyl ethers; and divinylarene dioxides such as divinylbenzene dioxide. In one embodiment, for example, the curable composition of the present invention may include at least one epoxy resin compound such as a liquid epoxy resin (LER).

Other embodiments of the epoxy compound used in the curable composition of the present invention, may be for example a single epoxy compound used alone; or a combination of two or more epoxy compounds known in the art such as any of the epoxy compounds described in Lee, H. and Neville, K., Handbook of Epoxy Resins, McGraw-Hill Book Company, New York, 1967, Chapter 2, pages 2-1 to 2-27, incorporated herein by reference. In a preferred embodiment, the epoxy compound may include for example epoxy resins based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known in the art include for example reaction products of epichlorohydrin with o-cresol novolacs, hydrocarbon novolacs, and, phenol novolacs. The epoxy compound may also be selected from commercially available epoxy resin products such as for example, D.E.R.™ 331, D.E.R.332, D.E.R. 354, D.E.R. 580, D.E.N.™ 425, D.E.N. 431, D.E.N. 438, D.E.R. 736, or D.E.R. 732 epoxy resins available from The Dow Chemical Company.

In another embodiment, the curable composition of the present invention may include at least one low viscosity epoxy resin compound as component (I) to form the epoxy matrix in a final curable formulation. For example, the low viscosity liquid epoxy resin compound useful in the present invention may include the epoxy compounds described in U.S. Pat. No. 8,497,387; U.S. Provisional Patent Application Ser. No. 61/660403, filed Jun. 15, 2012, by Maurice Marks; and U.S. Provisional Patent Application Ser. No. 61/718752, filed Oct. 26, 2012, by Stephanie Potisek et al., all of which are incorporated herein by reference.

In a preferred embodiment, the epoxy resin useful in the present invention can be, for example, liquid epoxy resins and include, but are not limited to, bisphenol-A diglycidyl ethers (BADGE), diglycidyl ether of bisphenol F, epoxy novolac resins, and mixtures thereof. Examples of bisphenol A diglycidyl ethers useful in the present invention include, but are not limited to, D.E.R. 331 and D.E.R. 383 commercially available from The Dow Chemical Company. Examples of epoxy novolac resins useful in the present invention include, but are not limited to, D.E.R. 354, D.E.N. 425, D.E.N. 431, and D.E.N. 438 commercially available from The Dow Chemical Company.

Generally, the amount of epoxy compound used in the curable composition of the present invention may be, for example, in the range of from about 10 wt % to about 95 wt % in one embodiment, from about 10 wt % to about 90 wt % in another embodiment; from about 10 wt % to about 80 wt % in still another embodiment; and from about 10 wt % to about 70 wt % in yet another embodiment, based on the total weight of the curable composition. In even still another embodiment, the concentration of epoxy compound used in the curable composition of the present invention may be, for example, in the range of from about 30 weight percent to about 92 weight percent.

In general, a curing agent (also referred to as a hardener or crosslinking agent), is used as component (IV) in the curable composition of the present invention. The curing agent may include, for example, any conventional curing agent known in the art suitable for curing epoxy resin-based compositions. In addition, the curing agent should be capable of mixing with the other compounds present in the curable composition without deleteriously affecting the curing reactions of the curable composition. The curing agent should also be capable of providing the second curing reaction as described above. For example, the curing agent useful in the curable composition of the present invention may be selected from, but is not limited to, an anhydride, an amine, a phenolic, and combinations thereof.

An anhydride is a compound having an anhydride group, e.g., two acyl groups bonded to the same oxygen atom. The anhydride can be symmetric or mixed. Symmetric anhydrides have identical acyl groups. Mixed anhydrides have different acyl groups. The anhydride useful in the present invention can be selected from the group consisting of hexahydrophthalic anhydride, methyltetrahydrophthalic anhydride, methylhexahydrophthalic anhydride, nadic methyl anhydride, methylbutenyltetrahydrophthalic anhydride, and combinations thereof.

Examples of the amine curing agent useful in the present invention may include, but are not limited to, aliphatic polyamines; arylaliphatic polyamines; cycloaliphatic polyamines; aromatic polyamines; heterocyclic polyamines; polyalkoxypolyamines; phenalkamines; and combinations thereof. In a preferred embodiment, the alkoxy group of the polyalkoxypolyamines can be, for example, an oxyethylene; an oxypropylene; oxy-1,2-butylene; oxy-1,4-butylene or a co-polymer thereof; and mixtures thereof.

Examples of aliphatic polyamines useful in the present invention can include, but are not limited to, ethylenediamine (EDA); diethylenetriamine (DETA); triethylenetetramine (TETA); tetraethylenepentamine (TEPA); trimethyl hexane diamine (TMDA); hexamethylenediamine (HMDA); N-(2-aminoethyl)-1,3-propanediamine (N3-Amine); N,N′-1,2-ethanediylbis-1,3-propanediamine (N4-amine); dipropylenetriamine; and mixtures thereof.

Examples of arylaliphatic polyamines useful in the present invention can include, but are not limited to, m-xylenediamine (mXDA); p-xylenediamine; and mixtures thereof.

Examples of cycloaliphatic polyamines useful in the present invention can include, but are not limited to, 1,3-bisaminomethyl cyclohexane (1,3-BAC); isophorone diamine (IPDA); 4,4′-methylenebiscyclohexanamine; bis-(p-aminocyclohexyl)methane; 1,2-diamino cyclohexane (1,2-DACH); and mixtures thereof.

Examples of aromatic polyamines useful in the present invention can include, but are not limited to, m-phenylenediamine; diaminodiphenylmethane (DDM); diaminodiphenylsulfone (DDS); and mixtures thereof.

Generally, the amount of the curing agent used in the curable composition of the present invention will depend on the enduse of the thermoset made from the curable composition. For example, as one illustrative embodiment, when the curable composition is used to prepare a composite, the concentration of curing agent can be generally from about 3 wt % to about 50 wt % in one embodiment, from about 5 wt % to about 50 wt %, in another embodiment; from about 10 wt % to about 45 wt % in still another embodiment; from about 15 wt % to about 40 wt % in yet another embodiment; from about 20 wt % to about 35 wt % in even still another embodiment, and from about 20 wt % to about 30 wt % curing agent in even yet another embodiment. The above wt % ranges correspond to about 1 equivalent of hardener for 1 equivalent of epoxy to have a stoichiometric balance. Above these ranges, there would be unreacted hardener (i.e., all the epoxy would be consumed); and below these ranges, there would be unreacted epoxy (i.e., not enough hardener).

Optional compounds that may be added to the curable composition of the present invention may include compounds that are normally used in resin formulations known to those skilled in the art for preparing curable compositions and thermosets. In addition, the optional compounds that may be added to the curable composition of the present invention may include one or more optional compounds that do not deleteriously affect the properties of the curable composition.

For example, the optional compounds that may be added to the curable composition of the present invention may include, reactive and non-reactive diluents, other resins different from the epoxy compound of the present invention such as a phenolic resin that can be blended with the epoxy resin of the formulation, other epoxy resin hardeners, other methacrylates which form networks by themselves as well as phase separate during the second epoxy-curing agent reaction, toughening agents, fillers, curing catalysts, de-molding agents, other accelerators, solvents to lower the viscosity of the formulation further, pigments, flow modifiers, adhesion promoters, stabilizers, plasticizers, catalyst de-activators, flame retardants, and mixtures thereof.

In a more preferred embodiment, the curable composition of the present invention may include further at least one compound selected from the group consisting of a second epoxy compound separate and different from the epoxy compound (III), a second curing agent separate and different from the curing agent composition (IV), a filler, a reactive diluent, a flexibilizing agent, a processing aide, a toughening agent, and a mixture thereof.

For example, in one preferred embodiment, the curable composition can be optionally diluted with a reactive diluent such as for example cresyl glycidyl ether (CGE); p.t.-butylphenyl glycidyl ether (ptBPGE); C12/C14 glycidyl ether; butanediol diglycidyl ether (BDDGE); hexanediol-diglycidyl ether (HDDGE); branched glycidyl ethers such as C13/C15 alcohol glycidyl ether; glycidyl esters such as versatic acid glycidyl esters; and mixtures thereof.

Generally, the amount of the optional components, when used in the present invention, may be for example from 0 wt % to about 10 wt % in one embodiment; from about 0.01 wt % to about 10 wt % in another embodiment; from about 0.01 wt % to about 8 wt % in still another embodiment; from about 0.1 wt % to about 5 wt % in yet another embodiment; and from about 0.5 wt % to about 4 wt % in even still another embodiment.

The process of providing a curable resin formulation, system or composition of the present invention may include mixing the methacrylated or acrylated polyol, the free radical initiator, the epoxy resin and the amine curing agent described above when the curable composition. The above curable resin composition is then thermally cured such that the curable composition undergoes two separate thermal curing reactions when the free radical initiator useful as component (II) in the present invention includes a thermal free radical initiator (i.e., an initiator which generates free radicals on heating).

Alternatively, after the components of the above curable resin composition are mixed to provide a reaction mixture, the mixture is then cured via a combination of at least two separate curing reactions—the first curing reaction occurring via UV free radical polymerization when the free radical initiator useful as component (II) in the present invention includes a UV free radical initiator (i.e., an initiator which generates free radicals by UV light absorption) to promote free radical polymerization of the methacrylated or acrylated polyol; and the second curing reaction occurring via thermal condensation curing between the epoxy compound and the epoxy hardener. Any of the optional additives described above can also be added to the curable composition. Optional components, for example a curing catalyst and other additives known to the skilled artisan, can be used in the curable composition for various enduse applications. For example, when a curing catalyst is used, the concentration of the curing catalyst in the curable composition may be from about 0.01 weight percent to about 10 weight percent.

For example, the curable resin formulation of the present invention is prepared by blending, in known mixing equipment, the components of the composition including a methacrylated or acrylated polyol, a free radical initiator, an epoxy resin, a curing agent as described above, and optionally any other desirable additives. Any optional additives, for example a curing catalyst, may be added to the composition during the mixing or prior to the mixing to form the curable composition.

All the compounds of the curable formulation are typically mixed and dispersed at a temperature enabling the preparation of an effective curable composition having the desired balance of properties for a particular application. For example, the temperature during the mixing of all components may be generally from about 0° C. to about 100° C. in one embodiment and from about 15° C. to about 50° C. in another embodiment.

The preparation of the curable formulation of the present invention, and/or any of the steps thereof, may be a batch or a continuous process. The mixing equipment used in the process may be any vessel and ancillary equipment well known to those skilled in the art.

The curable epoxy resin formulation or composition of the present invention advantageously exhibits a low viscosity; and hence, the composition is suitable for processes wherein a low viscosity curable composition is needed for ease of processing the composition through the operation. For example, enduse applications such as manufacturing prepregs and composites by infusion and filament winding would benefit from a low viscosity composition such as that of the present invention.

In one embodiment, the low viscosity curable composition of the present invention generally has a viscosity of less than about 500 mPa-s at 25° C. In another embodiment, the viscosity of the curable composition can range from about 10 mPa-s to about 500 mPa-s, from about 10 mPa-s to about 200 mPa-s in still another embodiment; from about 10 mPa-s to about 100 mPa-s in yet another embodiment; from about 10 mPa-s to about 50 mPa-s in even still another embodiment; and from about 10 mPa-s to about 25 mPa-s in even yet another embodiment, at 25° C. When a liquid epoxy resin is used to prepare the curable composition of the present invention for example, a divinylarene dioxide such as DVBDO, the curable epoxy resin composition of the present invention advantageously exhibits a low viscosity in the range of from about 0.001 Pa s to about 0.1 Pa s at 25° C. DVBDO itself has a very low liquid viscosity (for example less than about 20 mPa-s); thus, making DVBDO especially useful in the preparation of low viscosity curable epoxy compositions.

The curing of the composition of the present invention which involves first and second curing reactions of the curable composition includes a combination of free radical polymerization curing in the first curing reaction and thermal condensation curing in the second curing reaction. In this embodiment, for example, a free radical initiator is present in the curable composition to promote free radical polymerization of the methacrylated or acrylated polyol in the first curing reaction by subjecting the curable composition to thermal or UV exposure. In the second curing reaction, a condensation of the epoxy resin and curing occur by thermal curing methods.

As aforementioned, one embodiment of initiating the first and second curing reactions of the curable composition includes thermal curing the above-described curable resin compositions to form a thermoset or cured composition. The dual curing process for curing the curable composition may be carried out at a predetermined temperature and for a predetermined period of time sufficient to cure the composition via the first and second curing reactions. In some instances, the curing may be dependent on the hardeners used in the formulation.

In the embodiment of initiating the first and second curing reactions of the curable composition via thermal curing, the process of providing a curable resin formulation, system or composition of the present invention may include first admixing the components of the curable composition including the methacrylated or acrylated polyol, the free radical initiator, the epoxy resin compound, the curing agent, and any of the optional compounds described above; and then subjecting the curable composition to a thermal heat source for curing. In this embodiment, the curing temperature should be sufficient to provide the methacrylated or acrylated polyol to undergo a first curing reaction followed by a second curing reaction wherein the epoxy and curing agent undergo the second curing reaction. For example, generally the first and second curing reactions of the present invention, are carried out by thermally heating the curable composition to at least a temperature of greater than about 25° C. in one embodiment, and greater than about 30° C. in another embodiment; from about 25° C. to about 200° C. in still another embodiment; and from about 30° C. to about 200° C. in yet another embodiment.

In another embodiment, the thermal cure of the curable composition can be carried out in multiple stages and at different temperatures. For example, in one embodiment to provide the first curing reaction of curing the methacrylated or acrylated polyol includes thermal curing the methacrylated or acrylated polyol by heating the curable composition containing the methacrylated or acrylated polyol to at least a temperature of greater than about 30° C. in one embodiment; from about 30° C. to about 150° C. in another embodiment, and from about 25° C. to about 80° C. in still another embodiment. Then, the following second curing reaction of the present invention process, wherein the epoxy resin is cured with a curing agent, can be carried out thermally at a temperature of greater than about 70° C., in one embodiment; from about 30° C. to about 250° C. in another embodiment, and from about 60° C. to about 200° C. in still another embodiment.

Generally, the curing time for the curing process of the curable composition may be chosen between about 1 minute to about 10 hours in one embodiment, between about 5 minutes to about 7 hours in another embodiment, and between about 10 minutes to about 4 hours in still another embodiment. Below a period of time of about 1 minute, the time may be too short to ensure sufficient reaction under conventional processing conditions; and above about 10 hours, the time may be too long to be practical or economical.

In the embodiment of initiating the first and second curing reactions of the curable composition via a combination of UV exposure and thermal curing, respectively, the dual curing process for curing the curable composition may be carried out at a predetermined temperature and for a predetermined period of time for the UV conditions sufficient to cure the methacrylated or acrylated polyol via the first curing reaction in the composition; and at a predetermined temperature and for a predetermined period of time for the thermal conditions sufficient to cure the epoxy via the second epoxy-curing agent reaction in the composition. In this embodiment, the process of providing a curable resin formulation, system or composition of the present invention may include first admixing the components of the curable composition including the methacrylated or acrylated polyol, the UV free radical initiator, the epoxy resin compound, the curing agent, and any of the optional compounds described above; and then subjecting the curable composition to UV light source to perform the first curing reaction of the curable composition; and then subjecting the curable composition to a heat source to perform the second curing reaction of the curable composition.

The process conditions for the UV free radical polymerization of the methacrylated or acrylated polyol in the first curing reaction includes for example using a UV light at a wavelength of from about 100 nanometers to about 400 nanometer in one embodiment and from about 200 nanometers to about 350 nanometers in another embodiment. The curable composition can be contacted with UV light at a temperature of for example from about 0° C. to about 70° C.; and for a time of for example from about 1 minute to about 60 minutes.

The thermal conditions, sufficient to cure the epoxy with a hardener via the second epoxy-curing agent reaction in the composition, include heating the curable composition, for example, at a temperature generally from about 10° C. to about 250° C. in one embodiment; from about 60° C. to about 200° C. in another embodiment; and from about 90° C. to about 175° C. in still another embodiment.

Any of the optional compounds described above may be added to the curable composition of the present invention during the first and/or second curing reactions so long as the optional compounds described above do not deleteriously affect the UV free radical initiator curing reaction or the thermal curing reaction.

The cured product or thermoset (i.e. the cross-linked product made from the curable composition) of the present invention shows several beneficial mechanical and thermal properties. For example, the cured product of the present invention may advantageously have a high elongation property and a high modulus.

For example, the cured product of the present invention exhibits an elongation at break of generally > about 5% elongation in one embodiment and > about 10% elongation in another embodiment. In still another embodiment, the cured product of the present invention has an elongation at break of from > about 5% elongation to about 80%, elongation and from > about 10% elongation to about 70% elongation in still another embodiment. The elongation property of the cured product can be measured, for example, by the method described in ASTM D-638.

The thermoset produced from curing the curable composition of the present invention exhibits a tensile modulus of from about 0.5 Gpa to about 5 Gpa in one embodiment, from about 1 GPa to about 4 GPa in another embodiment, and from about 1.5 GPa to about 3 GPa in still another embodiment.

The thermoset produced from curing the curable composition of the present invention exhibits a tensile strength of from about 20 Mpa to about 90 Mpa in one embodiment, from about 25 Mpa to about 80 Mpa in another embodiment, and from about 30 Mpa to about 70 Mpa in still another embodiment.

The thermoset produced from curing the curable composition of the present invention exhibits a strain at break of from about 5% to about 100% in one embodiment, from about 5% to about 80% in another embodiment, and from about 5% to about 40% in still another embodiment.

The thermoset produced from curing the curable composition of the present invention exhibits a Tg, as measured by DSC, of from about 30° C. to about 250° C. in one embodiment, from about 50° C. to about 240° C. in another embodiment, and from about 60° C. to about 230° C. in still another embodiment.

Because the curable composition of the present invention exhibits a combination and balance of properties, when the curable composition is cured, the resulting thermoset product, in turn, exhibits unique and beneficial properties such as processability, Tg, and mechanical performance. For example, the curable composition advantageously has a low viscosity; and therefore, the curable epoxy resin compositions of the present invention are suitable for composite manufacture such as by an infusion and a filament winding process.

In a preferred embodiment, the curable composition of the present invention may be used to manufacture a cured thermoset product such as prepregs and composites. The curable composition of the present invention may also be used in applications including electronic applications such as capillary underfill formulations and electrically conductive adhesive formulations. The curable composition may also be used for electrically conductive adhesive (ECA) formulations; UV cure formulations such as for inks and coatings; laminate applications; and other coatings applications.

### EXAMPLES

The following examples and comparative examples further illustrate the present invention in detail but are not to be construed to limit the scope thereof.

Various terms and designations used in the following Examples are explained herein as follows:

IMA-P400 is SR-644, a methacrylated polyol wherein the polyol is polypropylene oxide of a molecular weight of 400 and commercially available from Sartomer.

MA-E400 is SR 603, a methacrylated polyol wherein the polyol is polyethylene oxide of a molecular weight of 400 and commercially available from Sartomer.

Airstone 780E is a mixture of a bisphenol A based epoxy resin and diglycidyl ether of 1,4-butanol and commercially available from The Dow Chemical Company.

Airstone 786H is an amine commercially available from The Dow Chemical Company.

Trigonox 23 is a free radical initiator commercially available from Akzo Nobel.

Syna Epoxy 21 is a cycloaliphatic epoxy resin (3,4-epoxy cyclohexyl methyl-3,4-epoxy cyclohexane carboxylate) and commercially available from Synasia.

“NMA” stands for nadic methyl anhydride and is commercially available from Dixie Chemical Company, USA.

Voranol 8000 is a polyether polyol commercially available from The Dow Chemical Company.

1-methyl imidazole is commercially available from Aldrich.

The following standard analytical equipment and methods are used in the Examples: The properties of the cured product, including percent elongation, tensile modulus, tensile strength, and strain at break were measured by the method described in ASTM D-638 using Instron equipment. The Tg property of the cured product was measured by the DSC method or the DMTA method on a DSCQ200 TA instrument or an Ares rheometer respectively.

### Example 1

Airstone 780E (128 g), Airstone 786H (40 g), MA-P400 (32 g), and Trigonox 23 (1.6 g) were added into a 300 mL (16 ounce) glass bottle. The resulting mixture of ingredients was mixed well to obtain a clear low viscosity liquid mixture. The liquid mixture was degassed by centrifugation. The liquid mixture was then poured into a rectangular mold (30 cm×20 cm) preheated to 50° C. The mold was placed in an oven and heated at 80° C. for 7 hours (hr) to produce an opaque thermoset. The resultant opaque thermoset product prepared as described in this Example 1 was tested and the results of the testing are described in Table I.

### Example 2

An opaque thermoset product was prepared using the same procedure described in Example 1 except that Airstone 780E (138 g), Airstone 786H (42 g), MA-P400 (20 g), and Trigonox 23 (1.6 g) were added into a 300 mL glass bottle. The results of testing the resultant opaque thermoset product of this example are described in Table I.

### Example 3

An opaque thermoset product was prepared using the same procedure described in Example 1 except that Airstone 780E (128 g), Airstone 786H (40 g), MA-E400 (32 g), and Trigonox 23 (1.6 g) were added into a 300 mL glass bottle. The results of testing the resultant opaque thermoset product of this example are described in Table I.

### Example 4

An opaque thermoset product was prepared using the same procedure described in Example 1 except that D.E.R. 383 (130 g), Airstone 786H (37.7 g), MA-P400 (32 g), and Trigonox 23 (1.6 g) were added into a 300 mL glass bottle. The results of testing the resultant opaque thermoset product of this example are described in Table I.

TABLE I

| | Example 1 | Example 2 | Example 3 | Example 4 |
|---|---|---|---|---|
| COMPOSITION | Airstone780E; | Airstone780E; | Airstone780E; | D.E.R. 383; |
| | Airstone | Airstone | Airstone 786H; | Airstone 786H; |
| | 786H; 16% | 786H; 10% | 16% MA-E400 | 16% MA-P400 |
| | MA-P400 | MA-P400 | | |
| PROPERTIES | | | | |
| Visual | opaque | opaque | opaque | opaque |
| Characteristic | thermoset | thermoset | thermoset | thermoset |
| Tensile Modulus | 2.3 ± 0.08 | 2.6 ± 0.05 | 2.1 ± 0.02 | 2.4 ± 0.05 |
| (Gpa) | | | | |
| Tensile Strength | 48 ± 0.9 | 52 ± 0.9 | 46 ± 0.4 | 50 ± 0.8 |
| (Mpa) | | | | |
| Strain at Break | 24 ± 3 | 19 ± 3.7 | 23 ± 5 | 20 ± 4 |
| (%) | | | | |
| Tg [DSC] (° C.) | 77/90 | 94/94 | 85/93 | 101/108 |

### Example 5

D.E.R. 383 (19 g), Syna Epoxy 21 (44 g), NMA (76 g), Voranol 8000 (30 g), 1-methyl imidazole (2 g), MA-P400 (30 g), and Trigonox 23 (1.6 g) were added into a 300 mL glass bottle. The resulting mixture of ingredients was mixed well to obtain a clear low viscosity liquid mixture. The liquid mixture was degassed by centrifugation. The liquid mixture was then poured into a rectangular mold (30 cm×20 cm) preheated to 50° C. The mold was placed in an oven and heated at 60° C. for 7 hr followed by 100° C. for 30 minutes (min), 150° C. for 30 min, and 200° C. for 30 min to produce an opaque thermoset. The resultant opaque thermoset product prepared as described in this Example 5 was tested and the results of the testing are described in Table II.

TABLE II

| | Example 5 |
|---|---|
| COMPOSITION | Epoxy resin; Anhydride; Voranol 8000; |
| | 1-methyl imidazole; MA-P400 |
| PROPERTIES | |
| Visual Characteristic | opaque thermoset |
| Tensile Modulus (Gpa) | 1.2 ± 0.02 |
| Tensile Strength (Mpa) | 23 ± 0.3 |
| Strain at Break (%) | 6 ± 0.06 |
| Tg [DMTA] (° C.) | 217 |

### Comparative Example A

D.E.R. 383 (130 g), Airstone 786H (37.7 g), trimethylolpropane trimethacrylate (32 g), and Trigonox 23 (1.6 g) were added into a 300 mL glass bottle. The resulting mixture of ingredients was mixed well to obtain a clear low viscosity liquid mixture. The liquid mixture was degassed by centrifugation. The liquid mixture was then poured into a rectangular mold (30 cm×20 cm) preheated to 50° C. The mold was placed in an oven and heated at 80° C. for 7 hr to produce a clear thermoset. The resultant clear thermoset product prepared as described in this Comparative Example A was tested and the results of the testing are described in Table III.

### Comparative Example B

An opaque thermoset product was prepared using the same procedure described in Comparative Example A except that D.E.R. 383 (130 g), Airstone 786H (37.7 g), PEO-MA (32 g), and Trigonox 23 (1.6 g) were added into a 300 mL glass bottle. The results of testing the resultant opaque thermoset product of this example are described in Table III.

### Comparative Example C

A clear thermoset product was prepared using the same procedure described in Comparative Example A except that Airstone 780E (153 g) and Airstone 786H (47 g) were added into a 300 mL glass bottle. The results of testing the resultant clear thermoset product of this example are described in Table III.

### Comparative Example D

An opaque thermoset product was prepared using the same procedure described in Comparative Example A except that Airstone 780E (145 g), Airstone 786H (45 g), MA-P400 (10 g), and Trigonox 23 (1.2 g) were added into a 300 mL glass bottle. The results of testing the resultant opaque thermoset product of this example are described in Table III.

TABLE III

| | Comparative | Comparative | Comparative | Comparative |
|---|---|---|---|---|
| | Example A | Example B | Example C | Example D |
| COMPOSITION | D.E.R. 383; | Airstone780E; | Airstone780E; | Airstone780E; |
| | Airstone 786H; | Airstone 786H; | Airstone 786H | Airstone 786H; |
| | 16% TMPTMA^{(a)} | 16% PEG-MA | | 5% MA-P400 |
| PROPERTIES | | | | |
| Visual | clear thermoset | opaque | clear thermoset | opaque |
| Characteristic | | thermoset | | thermoset |
| Tensile Modulus | 3.2 ± 0.05 | 2.2 ± 0.05 | 3.0 ± 0.04 | 2.9 ± 0.07 |
| (Gpa) | | | | |
| Tensile Strength | 80 ± 0.1 | 44 ± 1 | 70 ± 0.4 | 65 ± 0.8 |
| (Mpa) | | | | |
| Strain at Break | 5.0 ± 0.05 | 10 ± 3 | 9 ± 1 | 8.7 ± 2.6 |
| (%) | | | | |
| Tg [DSC] (° C.) | 93/97 | 82/87 | 94/77 | 85/91 |

^{(a)}trimethylol propane trimethacrylate

### Comparative Example E

D.E.R. 383 (23 g), Syna Epoxy 21 (54 g), NMA (93 g), Voranol 8000 (30 g) and 1-methyl imidazole (2 g) were added into a 300 mL glass bottle. The resulting mixture of ingredients was mixed well to obtain a clear low viscosity liquid mixture. The liquid mixture was degassed by centrifugation. The liquid mixture was then poured into a rectangular mold (30 cm×20 cm) preheated to 50° C. The mold was placed in an oven and heated at 60° C. for 7 hr followed by 100° C. for 30 min, 150° C. for 30 min, and 200° C. for 30 min to produce an opaque thermoset. The mechanical properties of the opaque thermoset were measured in accordance with the procedure described in ASTM D-638; and the results of such measurements of the opaque thermoset product prepared in this Comparative Example E are described in Table IV.

TABLE IV

| | Comparative Example E |
|---|---|
| COMPOSITION | Epoxy resin; Anhydride; Voranol 8000; |
| | 1-methyl imidazole |
| PROPERTIES | |
| Visual Characteristic | opaque thermoset |
| Tensile Modulus (Gpa) | 1.7 ± 0.03 |
| Tensile Strength (Mpa) | 27 ± 1 |
| Strain at Break (%) | 2.5 ± 0.2 |
| Tg [DMTA] (° C.) | 224 |

1. A curable epoxy resin composition comprising a mixture of the following compounds:
(I) at least one methacrylated or acrylated polyol compound;
(II) at least one free radical initiator;
(III) at least one epoxy compound; and
(IV) at least one curing agent;
wherein the curable composition being curing, a first curing reaction occurs wherein the at least one methacrylated or acrylated polyol cures first by free radical polymerization followed by a second curing reaction wherein the at least one epoxy compound cures with the at least one curing agent by a condensation reaction to provide a thermoset having an elongation property of greater than 5 percent.

2. The curable composition of claim 1, wherein the at least one methacrylated or acrylated polyol compound is compound represented by the chemical structure as described in Structure (I) as follows: 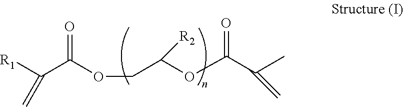
wherein R₁ can be H or CH₃ and R₂ can be H, CH₃ or higher homologues or a mixture thereof; and n can be an integer of from 3 to about 30.

3. The curable composition of claim 1, wherein the at least one methacrylated polyol compound is compound represented by the chemical structure as described in Structure (II) or Structure (III) as follows: 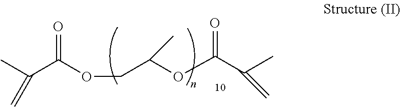
wherein n can be an integer of from 3 to about 10; 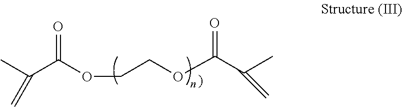
wherein n can be an integer of from 3 to about 10.

4. The curable composition of claim 3, wherein n is 7 in Structure (II) and Structure (III) and the at least one methacrylated polyol compound is polypropylene glycol dimethacrylate.

5. The curable composition of claim 1, wherein the at least one free radical initiator is a thermal initiator or a UV initiator.

6. The curable composition of claim 1, wherein the at least one free radical initiator is a UV photoinitiator; and the UV photoinitiator is 2,2-dimethoxy 2-phenyl acetophenone.

7. The curable composition of claim 1, wherein the at least one epoxy compound is diglycidyl ether of bisphenol A.

8. The curable composition of claim 1, wherein the at least one curing agent is an amine curing agent.

9. The curable composition of claim 1, wherein the at least one curing agent is selected from the group consisting of aliphatic polyamines; aryl aliphatic polyamines; cycloaliphatic polyamines; aromatic polyamines; heterocyclic polyamines; polyalkoxypolyamines; phenalkamines; and combinations thereof.

10. The curable composition of claim 1, wherein the at least one curing agent is an anhydride.

11. The curable composition of claim 1, including further at least one curing catalyst.

12. A thermoset product comprising a reaction product of:
(a) at least one methacrylated or acrylated polyol compound;
(b) at least one free radical initiator;
(c) at least one epoxy compound; and
(d) at least one curing agent;
wherein the reaction product being reacted, a first curing reaction occurs wherein the at least one methacrylated or acrylated polyol cures first by free radical polymerization followed by a second curing reaction wherein the at least one epoxy compound cures with the at least one curing agent by a condensation reaction; and wherein the thermoset product has an elongation property of greater than 5 percent.

13. A process for preparing a thermoset product comprising the steps of:
(A) admixing the following components:
(a) at least one methacrylated or acrylated polyol compound;
(b) at least one free radical initiator;
(c) at least one epoxy compound; and
(d) at least one curing agent; and
(B) curing the composition of step (A) to form a thermoset by:
(i) a first curing reaction including polymerizing
(a) the methacrylated or acrylated polyol compound by
(b) the free radical initiator to form a network; and
(ii) subsequently, a second curing reaction including reacting
(c) the epoxy compound and
(d) the curing agent to form an epoxy-curing agent thermoset;
wherein the network formed in the first curing reaction of step (Bi) undergoes phase separation from the epoxy-curing agent thermoset formed in the second curing reaction of step (Bii) during formation of the epoxy-curing agent thermoset of the second curing reaction of step (Bii); and wherein the thermoset product has an elongation property of greater than 5 percent.

14. A cured thermoset article prepared by the process of claim 13.

15. The cured thermoset article of claim 14 comprising a composite.
